(19) United States
(12) Patent Application Publication
(10) Pub. No.: US 2026/0148589 A1
(43) Pub. Date: May 28, 2026

(54) MOBILE DEVICE USER AUTHENTICATION SYSTEM INCLUDING A MULTISPECTRAL SENSOR

(71) Applicant: Lenovo (Beijing) Limited, Beijing (CN)

(72) Inventors: Ranjeet Gupta, Aurora, IL (US); Rahul Bharat Desai, Hoffman Estates, IL (US); Binsheng Que, Xiamen (CN)

(73) Assignee: Lenovo (Beijing) Limited, Beijing (CN)

(21) Appl. No.: 19/371,292

(22) Filed: Oct. 28, 2025

Related U.S. Application Data
(63) Continuation of application No. PCT/CN2024/135042, filed on Nov. 27, 2024.

(51) Int. Cl. G06V 40/40; G06F 21/32; G06V 10/147; G06V 10/74; G06V 40/16

(52) U.S. Cl. CPC G06V 40/40; G06F 21/32; G06V 10/147; G06V 10/761; G06V 40/172

(57) ABSTRACT

In aspects of controlling access to mobile device functionality, a mobile device implements user authentication system with a multispectral sensor that is employed to detect indicators of active biological processes of users. Data generated by the multispectral sensor is compared to reference data to determine whether the data describes features belonging to a living user. The detection of features belonging to a living user can be leveraged along with a result of facial recognition processes to provide access to functionality of the mobile device for authorized users and deny access to the functionality for unauthorized users.

### RELATED APPLICATION

This application claims priority benefit of Application Number PCT/CN 2024/135042 filed 27 Nov. 2024 entitled “Mobile Device User Authentication System Including a Multispectral Sensor,” the disclosure of which is incorporated by reference herein in its entirety.

### BACKGROUND

As technology has advanced our uses for mobile devices have expanded. One such use is small mobile devices, such as smartphones, which have become increasingly powerful despite their small size. These mobile devices provide a great deal of portable processing power but are not without their problems. One such problem is that as mobile devices become smaller and support functionality such as facilitating transactions, online browsing, email access, and so forth, such mobile devices can contain sensitive user information such as confidential messages, digital images, browsing history, etc. In order to secure user information from being accessed by unauthorized individuals, some mobile devices may employ facial recognition techniques to determine whether an individual attempting to access functionality of the mobile device is authorized to do so. However, reliance solely on facial recognition techniques can cause devices to be susceptible to spoofing. For example, facial recognition techniques may be manipulated by unauthorized individuals to enable the unauthorized individuals to gain access to functionality of a mobile device. Securing a mobile device from unauthorized access can thus be frustrating for users, leading to user frustration with their devices.

### BRIEF DESCRIPTION OF THE DRAWINGS

Embodiments of a mobile device user authentication system including a multispectral sensor are described with reference to the following drawings. The same numbers are used throughout the drawings to reference like features and components:

FIG. 1 illustrates an example system implementing the techniques discussed herein;

FIG. 2 illustrates an example implementation of a mobile device user authentication system including a multispectral sensor;

FIG. 3 illustrates an example of acquiring environmental input via a multispectral sensor included in a mobile device user authentication system using the techniques discussed herein;

FIG. 4 illustrates an example of controlling access to functionality of a mobile device using the techniques discussed herein;

FIG. 5 illustrates an example multispectral sensor;

FIGS. 6 and 7 illustrate example processes for implementing the techniques discussed herein in accordance with one or more embodiments;

FIG. 8 illustrates various components of an example mobile device that can implement embodiments of the techniques discussed herein.

### DETAILED DESCRIPTION

A mobile device user authentication system including a multispectral sensor is discussed herein. Generally, a mobile device can be a portable computing device such as a smartphone, tablet, laptop computer, etc. Such mobile devices often include cameras with image sensors for generating digital images and/or digital videos, supporting live video streaming operations, and so forth. For example, a mobile device such as a smartphone may include one or more camera image sensors configured to acquire two-dimensional digital images of people, objects, and/or other features within an environment of the mobile device. The digital images may include red, green, and blue (RGB) color data assigned to pixels of the digital images based on light detected by the one or more image sensors of the camera.

In some configurations, mobile devices including camera image sensors may employ such sensors to image users of the devices to perform facial recognition. For example, a smartphone may use camera image sensors to acquire a digital image of an individual physically holding the smartphone. The smartphone may be adjusted between a locked mode and an unlocked mode based whether the individual depicted by the digital image matches a known authorized user of the smartphone (e.g., an owner of the smartphone associated with a user account or user profile of the smartphone). Some features of the smartphone may be hidden or inaccessible while the smartphone operates in the locked mode, and said features may be made visible or available for interaction while the smartphone operates in the unlocked mode. By employing such facial recognition techniques, it may be possible to reduce a likelihood of unauthorized access to such devices.

However, such techniques are not without issues. For example, in some situations it may be possible to cause such facial recognition techniques to falsely determine that an authorized user is depicted in a digital image. Such false determinations may lead to individuals acquiring unauthorized access to devices, which can cause undesired exposure of sensitive user information, undesired changes made to settings and/or applications of the devices, and so forth. Although some approaches such as fingerprint verification may provide another layer of device security, such approaches can be cumbersome and delay authorized users from timely accessing their devices. Additionally, some approaches utilize a three-dimensional image sensor, such as a time-of-flight (TOF) sensor, to acquire depth information, e.g., a distance of facial features of an individual from the image sensor. However, such sensors can be costly and may be associated with relatively high power consumption, computational resource consumption (e.g., use of device memory, processor load, etc.), and/or occupied packaging space compared to two-dimensional image sensors. This can lead to mobile device configurations that may be larger, less portable, have decreased battery life, and/or have decreased processing capacity available for other operations. Thus, there is a desire to increase a robustness and user-friendliness of security measures used to prevent unauthorized access to mobile devices.

According to the techniques described herein, a mobile device includes a user authentication system employing a multispectral sensor. The multispectral sensor is employed to detect indicators of one or more active biological processes of a user, and the user authentication system controls access to functionality of the mobile device based at least in part on the indicators. The active biological processes may include respiration of the user, blood circulation of the user, electromagnetic field generation by the user, and/or presence of chromophores in skin or other tissues of the user. If the indicators are detected, the user authentication system compares the indicators of such active biological processes to reference data to determine whether a source of the indicators is a living human. Access to a functionality of the mobile device, such as one or more user interfaces, applications, etc., is controlled at least in part based on an outcome of the comparison. If the indicators are not detected, the user authentication system may deny access to the functionality of the mobile device. In this way, the user authentication system increases security of the mobile device (e.g., protects user information from unauthorized access) by ensuring that access to the functionality of the mobile device is provided during conditions in which an authorized user is living and physically present at a location of the mobile device, and access may be denied during other conditions (e.g., when an authorized user is not living and/or not physically present).

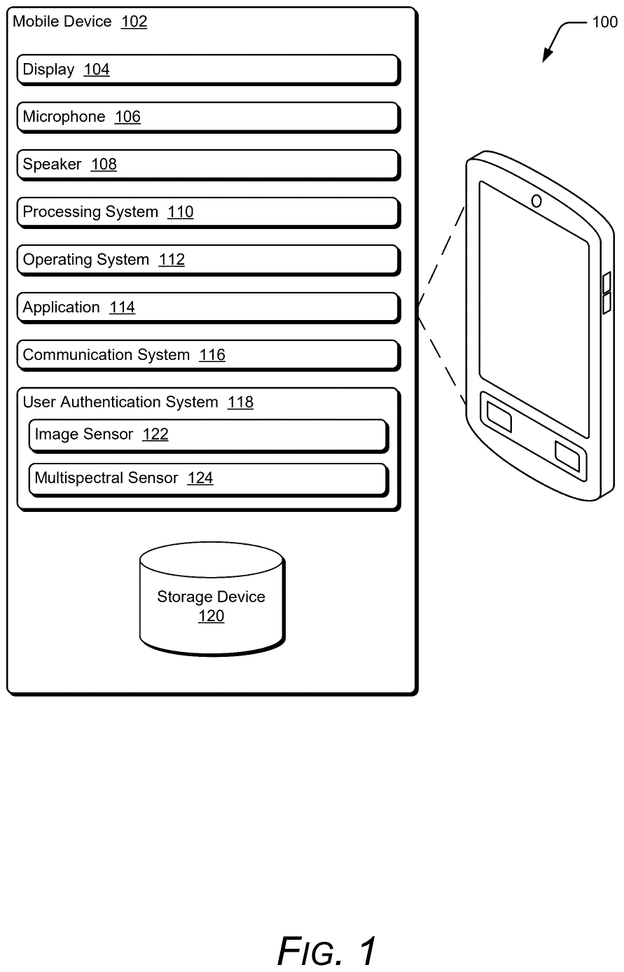

FIG. 1 illustrates an example system 100 implementing the techniques discussed herein. The system 100 includes a mobile device 102 that can be, or include, many different types of computing or electronic devices. For example, the mobile device 102 can be a smartphone or other wireless phone, a camera (e.g., compact or single-lens reflex), a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth. Although typically a smaller device, the mobile device 102 can be larger (e.g., a tablet or phablet computer, a notebook computer (e.g., netbook or ultrabook), a laptop computer, and so forth.

The display 104 can be configured as any suitable type of display, such as an organic light-emitting diode (OLED) display, active matrix OLED display, liquid crystal display (LCD), in-plane shifting LCD, and so forth. The display 104 can be touch enabled or not touch enabled. A touch-enabled device refers to a device that receives touch inputs via the display (e.g., a touchscreen). A touch-enabled device may also receive inputs via other input mechanisms, such as trackpad, mouse, physical keyboard, and so forth. A non-touch-enabled device refers to a device that does not receive touch inputs via the display (e.g., a touchscreen). Accordingly, a non-touch-enabled receives inputs via other input mechanisms, such as trackpad, mouse, physical keyboard, and so forth.

The mobile device 102 also includes a microphone 106 and a speaker 108. The microphone 106 can be configured as any suitable type of microphone incorporating a transducer that converts sound into an electrical signal, such as a dynamic microphone, a condenser microphone, a piezoelectric microphone, and so forth. The speaker 108 can be configured as any suitable type of speaker incorporating a transducer that converts an electrical signal into sound, such as a dynamic loudspeaker using a diaphragm, a piezoelectric speaker, non-diaphragm based speakers, and so forth.

The mobile device 102 also includes a processing system 110 that includes one or more processors, each of which can include one or more cores. The processing system 110 is coupled with, and may implement functionalities of, any other components or modules of the mobile device 102 that are described herein. In one or more embodiments, the processing system 110 includes a single processor having a single core. Alternatively, the processing system 110 includes a single processor having multiple cores or multiple processors (each having one or more cores).

The mobile device 102 also includes an operating system 112. The operating system 112 manages hardware, software, and firmware resources in the mobile device 102. The operating system 112 manages one or more applications 114 running on the mobile device 102 and operates as an interface between applications 114 and hardware components of the mobile device 102.

The mobile device 102 also includes a communication system 116. The communication system 116 is operable to manage communication with various other devices. The mobile device 102 can be connected to one or more external devices and communicate with the external devices using any of a variety of wired or wireless connections, such as USB, USB-C, WiFi™, WiFi™ IP (Internet Protocol), USB IP, DisplayPort, High-Definition Multimedia Interface (HDMI), and so forth.

The mobile device 102 includes a user authentication system 118 configured to control access to functionality of the mobile device 102 (e.g., access to one or more applications such as application 114, access to the operating system 112, access to operation of components such as the microphone 106, etc.). The user authentication system 118 that can be implemented in a variety of different manners. For example, the user authentication system 118 can be implemented at least in part as multiple instructions stored on computer-readable storage media and that can be executed by the processing system 110. Additionally or alternatively, the user authentication system 118 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The mobile device 102 also includes a storage device 120. The storage device 120 can be implemented using any of a variety of storage technologies, such as magnetic disk, optical disc, Flash, or other solid state memory, and so forth. The storage device 120 can store various program instructions and data for any one or more of the operating system 112, application 114, and the user authentication system 118.

The user authentication system 118 is depicted including an image sensor 122. The image sensor 122 may be employed by the mobile device 102 for generating digital images, e.g., digital photographs. For example, the image sensor 122 may be configured as a digital sensor of a camera integrated with the mobile device 102, where the camera includes a lens, one or more illumination sources (e.g., light-emitting diodes to support a flash function of the camera), and/or other components. The user authentication system 118 may employ the image sensor 122 for performing operations relating to user authentication. For example, the user authentication system 118 may employ the image sensor 122 to acquire one or more digital images of an individual requesting access to functionality of the mobile device 102. The user authentication system 118 may utilize the one or more acquired images to perform facial recognition operations as described further below.

The user authentication system 118 additionally includes a multispectral sensor 124. The multispectral sensor 124 is a sensor configured to detect light various wavelengths of light in the non-visible spectrum, e.g., infrared light, ultraviolet light, etc. In some implementations, the multispectral sensor 124 may include one or more filters configured to filter light incident to the multispectral sensor 124. For example, the multispectral sensor 124 may include an infrared filter configured to filter (e.g., block) light having a wavelength that is not within a pre-determined range of wavelengths (e.g., a range including wavelengths associated with infrared light).

In some implementations, the multispectral sensor 124 is integrated with the mobile device 102 to support additional functionality associated with operation of the image sensor 122. For example, the mobile device 102 may employ the multispectral sensor 124 during acquisition of digital images via the image sensor 122 to increase a quality of images acquired by the image sensor 122. In examples, the multispectral sensor 124 may be employed by the mobile device 102 to increase a color accuracy of digital images acquired by the image sensor 122 (e.g., through detecting wavelengths of light that may otherwise not be detected by the image sensor 122), to detect multiple illumination sources within an environment of the mobile device 102 (e.g., through detecting areas of high intensity of infrared light, ultraviolet light, or other non-visible light), to increase an accuracy of white balancing of digital images acquired via the image sensor 122 (e.g., through determining the white balance based on visible light detected by the image sensor 122 as well as non-visible light detected by the multispectral sensor 124), to detect chromophores of skin or other tissues of human subjects imaged by the image sensor 122 for accuracy of reflectance depicted by the digital images, etc.

In implementations, the multispectral sensor 124 is configured to detect electromagnetic fields. Detection of electromagnetic fields may include detection of an intensity (e.g., magnitude) and/or direction of electromagnetic fields at various locations within the environment of the mobile device 102. In some implementations, the mobile device 102 may utilize data generated responsive to detection of electromagnetic fields by the multispectral sensor 124 to map or otherwise identify the electromagnetic fields within the environment.

In some implementations, the multispectral sensor 124 and the image sensor 122 are configured to utilize a single lens of the mobile device 102 to receive light from the environment of the mobile device 102. For example, each of the multispectral sensor 124 and the image sensor 122 may be arranged behind the lens such that the lens is used by both of the multispectral sensor 124 and the image sensor 122 during detection of light within the environment of the mobile device 102.

The data generated by the multispectral sensor 124 describing light received from the environment of the mobile device 102 may be two-dimensional data. For example, in contrast to three-dimensional infrared sensors (e.g., TOF sensors) that utilize a laser or other component to measure a distance to various objects within the environment to generate three-dimensional data, the multispectral sensor 124 may not include such components and thus may be operated with a lower power consumption and/or lower usage of computational resources of the mobile device 102 (e.g., for processing of the generated data).

In some implementations, the data generated by the multispectral sensor 124 describing infrared light received from the environment may identify an intensity of infrared light received by individual photosensitive elements (e.g., photodiodes) in an array of photosensitive elements of the multispectral sensor 124. For example, the multispectral sensor 124 may include an array of photosensitive elements arranged in a grid extending in an x-direction and a y-direction, and the data generated by the multispectral sensor 124 may specify the intensity of infrared light received at each photosensitive element in the grid. In some implementations, the data generated by the multispectral sensor 124 may be used by the mobile device 102 to form a two-dimensional infrared image of the environment in which the mobile device 102 is located. Generation of two-dimensional data via the multispectral sensor 124 may occur more quickly than generation of three-dimensional data by other sensors (e.g., data describing light intensity as well as a distance of the sensors from objects reflecting the light detected by the sensors).

In accordance with the described techniques, the user authentication system 118 employs the multispectral sensor 124 to generate data that may describe indicators of one or more active biological processes of individuals requesting access to functionality of the mobile device 102. For example, responsive to receiving a request for access to functionality of the mobile device 102 input by an individual, the user authentication system 118 controls the multispectral sensor 124 to generate data from light received by the multispectral sensor 124. The data may describe, for example, infrared light emitted by (or reflected from) surfaces of the body of the individual (e.g., from skin or other tissues) indicating circulatory activity (e.g., blood flow), infrared light emitted by (or reflected from) respiration gases (e.g., air exhaled by the individual), electromagnetic fields associated with active facial features of the individual (e.g., electromagnetic fields around the head of the individual resulting from blood flow or other biological processes), and/or chromophores of skin or other tissues of the face of the individual.

Requests to access functionality of the mobile device 102 may include, for example, input to one or more buttons or other user interface elements of the mobile device 102. Requests to access functionality may occur, for example, during conditions in which the mobile device 102 is in a locked condition (also referred to as a locked mode). The locked condition refers to a condition of the mobile device 102 in which functionality such as graphical user interface elements, applications, menus, settings, and/or other features are inaccessible until the presence of an authorized user at the location of the mobile device 102 has been authenticated (e.g., verified) by the mobile device 102. Authentication of an individual may include imaging the individual using the image sensor 122 and performing facial recognition using data generated by the image sensor 122 to verify whether facial features of the individual match facial features known by the mobile device 102 to belong to an authorized user.

In some implementations, the multispectral sensor 124 may be active (e.g., generating data based on light received by the multispectral sensor 124 as described above) while authentication is being performed and may be inactive during conditions in which authentication is not being performed. In other implementations, the multispectral sensor 124 may be active while authentication is being performed and may additionally be active during other conditions (e.g., while the mobile device 102 is powered on, while operating one or more applications of the mobile device 102 such as a web browser, while acquiring digital images via the image sensor 122, etc.). In implementations in which the multispectral sensor 124 is activated while authentication is being performed, the detection of indicators of active biological processes may be periodically performed (e.g., in five minute intervals, ten minute intervals, etc.). If a live individual is not detected, the user authentication system 118 may adjust the mobile device 102 to the locked condition until successful authentication of an authorized user is performed.

“Active biological processes” as described herein refers to biological processes of the body of a living human individual such as blood flow, respiration, perspiration, etc. “Active facial features” as described herein refers to the real physical facial features of a living human individual (e.g., not images or other representations of the facial features) present at a location of the mobile device.

In some configurations, the data generated by the multispectral sensor 124 may be compared with data generated by the image sensor 122. The user authentication system 118 may use, for example, image data generated from visible light received by the image sensor 122 together with data generated from non-visible light (e.g., ultraviolet light) received by the multispectral sensor 124 to identify one or more active biological processes of a user (e.g., blood flow and circulation).

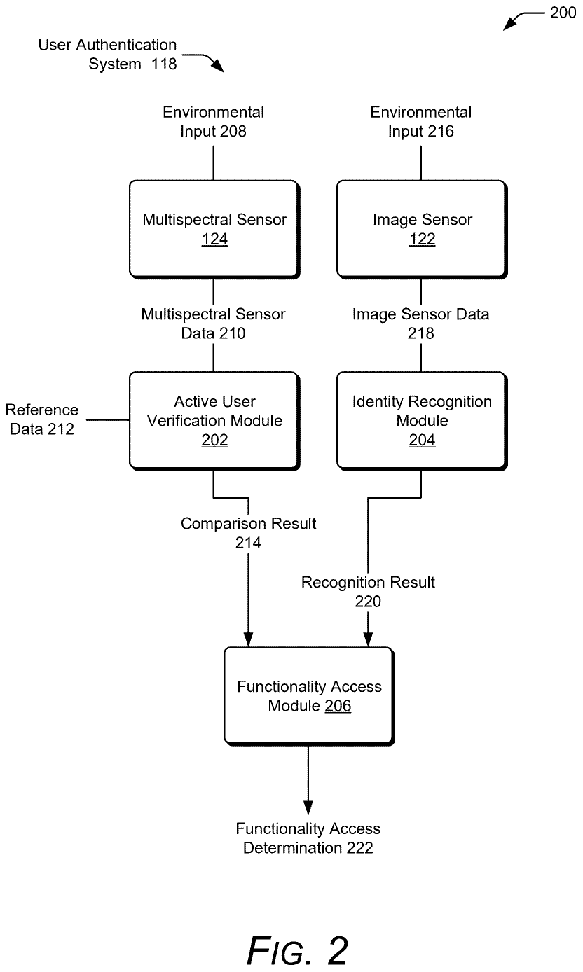

FIG. 2 illustrates an example 200 showing an implementation of the user authentication system 118 including the multispectral sensor 124. In the depicted implementation, the user authentication system 118 includes the multispectral sensor 124, the image sensor 122, an active user verification module 202, an identity recognition module 204, and a functionality access module 206.

In an example operation of the user authentication system 118, the multispectral sensor 124 receives environmental input 208. The environmental input 208 may include, for example, light (e.g., infrared light, ultraviolet light, blended light, etc.) within the environment of the mobile device 102 that is incident to the multispectral sensor 124. The multispectral sensor 124 receives the environmental input 208 and generates multispectral sensor data 210 based on the environmental input 208. The multispectral sensor data 210 may include one or more indicators of active biological processes of an individual requesting access to functionality of the mobile device 102 as described above, for example, in situations in which a live individual is present and unobscured (e.g., without facial coverings or other objects arranged between the face of the individual and the multispectral sensor 124).

The multispectral sensor data 210 is provided to the active user verification module 202. The active user verification module 202 may additionally receive reference data 212. In some implementations, the reference data 212 may be stored locally to the mobile device 102, e.g., within the storage device 120. In some implementations, the reference data 212 may be stored remotely from the mobile device 102 (e.g., located within cloud storage accessible to the mobile device 102 via a network, such as a cellular network).

The reference data 212 may describe, for example, one or more thresholds (e.g., threshold values). The reference data 212 may additionally or alternatively describe data associated with one or more authenticated users of the mobile device 102 (e.g., digital images of the users, data describing an intensity of infrared light emitted by, or reflected from, facial features and/or respiration gases of the users, chromophores of the users, electromagnetic field intensities and/or field directions associated with the users, etc.). In some implementations, the reference data 212 is acquired during registration of users as authorized users with the mobile device 102. In some instances, registration of the users as authorized users may be facilitated by the user authentication system 118 using the operating system 112 and/or application 114.

The active user verification module 202 is employed to compare the multispectral sensor data 210 to the reference data 212. The comparing may include, for example, determining whether indicators of active biological processes described by the multispectral sensor data 210 satisfy at least one condition based on the reference data 212. Conditions to be satisfied may include, for example, a similarity between the indicators described by the multispectral sensor data 210 and the reference data 212 greater than a threshold similarity. The similarity may be determined (e.g., calculated) by the mobile device 102 using one or more data similarity algorithms. The data similarity algorithms may be stored within the storage device 120, for example.

In some implementations, the user authentication system 118 may employ one or more machine-learning models to determine whether the multispectral sensor data 210 satisfies at least one condition based on the reference data 212. For example, one or more machine-learning models may be trained to determine (e.g., detect) similarity between the indicators described by the multispectral sensor data 210 and the reference data 212. The one or more machine-learning models may be trained using the reference data 212 in some instances. As used herein, the term “machine-learning model” refers to a computer representation that is tunable (e.g., through training and retraining) based on inputs without being actively programmed by a user to approximate unknown functions, automatically and without user intervention. A machine-learning model may be a multi-modal model utilizing networks and algorithms to learn from, and make predictions on, known data by analyzing training data to learn and relearn to generate outputs that reflect patterns and attributes of the training data. For example, the one or more machine-learning models may employ one or more neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. for performing the techniques described herein.

In some implementations, the at least one condition to be satisfied is based on the thresholds described by the reference data 212. For example, the one or more thresholds may include an infrared light intensity threshold, an electromagnetic field intensity threshold, a chromophore reflectance threshold, and/or a similarity threshold (as described above). Satisfying the at least one condition may include determining that values within the multispectral sensor data 210 are greater than corresponding values within the reference data 212. For example, in some instances, satisfying the at least one condition may include determining that an average infrared light intensity described by the multispectral sensor data 210 is greater than an infrared light intensity threshold described by the reference data 212. In some instances, the compared values may be within specific regions or zones described by the reference data 212 (e.g., infrared light intensity values of the multispectral sensor data 210 that compared with the reference data 212 may correspond to values associated with particular facial features of a user such as a nose, mouth, forehead, etc.). Satisfying the at least one condition indicates to the user authentication system 118 that the multispectral sensor data 210 depicts indicators of active biological processes associated with facial features of a living human physically present at a location of the mobile device 102.

The active user verification module 202 outputs a comparison result 214 based on the comparing of the multispectral sensor data 210 with the reference data 212. The comparison result 214 may describe, for example, whether the multispectral sensor data 210 satisfies the at least one condition based on the comparison of the multispectral sensor data 210 with the reference data 212. As described above, in some implementations, the active user verification module 202 compares numerical values described by the multispectral sensor data 210 to one or more numerical value ranges specified by the reference data 212. If the numerical values of the multispectral sensor data 210 are within ranges specified by the reference data 212 (e.g., the values of the multispectral sensor data 210 are greater than the threshold values described by the reference data 212), the active user verification module 202 may determine that the multispectral sensor data 210 satisfies a similarity condition and may output the comparison result 214 indicating that the similarity condition is satisfied. However, if the numerical values of the multispectral sensor data 210 are outside of the ranges specified by the reference data 212 (e.g., the values of the multispectral sensor data 210 are less than the threshold values described by the reference data 212), the active user verification module 202 may determine that the multispectral sensor data 210 does not satisfy the similarity condition and may output the comparison result 214 indicating that the similarity condition is not satisfied.

The comparison result 214 is received by a functionality access module 206. The functionality access module 206 is employed to control access to functionality of the mobile device 102 based at least on the multispectral sensor data 210 (e.g., based on whether the amount of similarity between the multispectral sensor data 210 and the reference data 212 satisfies the at least one condition). As described above, the comparison result 214 indicates whether the at least one condition is satisfied. The functionality access module 206 processes (e.g., evaluates) the comparison result 214 and controls access to the functionality of the mobile device 102 (e.g., one or more graphical user interface portions, data, etc.) based at least in part on the content of the comparison result 214. For example, the functionality access module 206 may enable access to functionality of the mobile device 102 or disable access to functionality of the mobile device 102 based at least in part on a content of the comparison result 214.

In some implementations, the functionality access module 206 controls access to the functionality of the mobile device 102 based on the comparison result 214 and further based on additional data received from the identity recognition module 204. For example, responsive to the functionality access module 206 receiving the comparison result 214 and determining that the content of the comparison result 214 indicates that the at least one condition has been satisfied by the multispectral sensor data 210, the user authentication system 118 may initiate a facial recognition process using the image sensor 122 and the identity recognition module 204. The access to the functionality of the mobile device 102 may be based on the comparison result 214 and further based on an outcome of the facial recognition process.

In an example operation, the user authentication system 118 initiates the facial recognition process with image sensor 122 receiving environmental input 216 and generating image sensor data 218 based on the environmental input 216. The environmental input 216 may include, for example, visible light received from the environment of the mobile device 102, such as visible light reflected by surfaces of facial features of the individual requesting access to the functionality of the mobile device 102. The image sensor data 218 may thus be a digital image that depicts the facial features of the individual and is generated based the environmental input 216.

The image sensor data 218 is provided to the identity recognition module 204, and the identity recognition module 204 performs one or more facial recognition operations using the image sensor data 218 to determine whether facial features of the individual depicted by the image sensor data 218 match facial features of an authorized user of the mobile device 102. In some implementations, the facial recognition operations may be performed using one or more suitable facial recognition algorithms in some implementations. In some implementations, the identity recognition module 204 may employ one or more machine-learning models trained to detect facial features from the image sensor data 218 and compare the detected facial features to corresponding facial features of authorized users known to the user authentication system 118 (e.g., based on facial feature data of authorized users stored in the storage device 120 and/or in cloud-based storage).

The identity recognition module 204 outputs the recognition result 220 indicating whether the facial features of the individual depicted by the image sensor data 218 match the facial features of an authorized user of the mobile device 102. The recognition result 220 is received by the functionality access module 206, and access to the functionality of the mobile device 102 may be based on each of the comparison result 214 and the recognition result 220. For example, the functionality access module 206 may provide access to the functionality of the mobile device 102 (e.g., unlock the functionality) for the individual requesting access to the functionality responsive to conditions in which, during a single request for access to the functionality, the comparison result 214 indicates that the at least one condition is satisfied and the recognition result 220 indicates that the facial features of the individual match facial features of an authorized user. However, if during the single request the comparison result 214 indicates that the condition is not satisfied or the recognition result 220 indicates that the facial features of the individual do not match facial features of an authorized user, the functionality access module 206 may deny access to the functionality of the mobile device 102 for the individual.

In some implementations, the comparison result 214 is generated prior to generation of the recognition result 220 as described above (e.g., with the facial recognition process occurring responsive to the comparison result 214 indicating that the at least one condition is satisfied). In other implementations, the comparison result 214 may be generated after the facial recognition process is performed and the recognition result 220 indicates that the facial features of the individual match the facial features of an authorized user.

The functionality access module 206 outputs device access determination 222 based on the determinations described above (e.g., the determinations involving the comparison result 214 and the recognition result 220). The device access determination 222 indicates whether access to the functionality of the mobile device 102 is to be provided or denied. Based on the device access determination 222, the user authentication system 118 provides the requested access to the functionality of the mobile device 102 (e.g., by enabling access to portions of operating system 112, application 114, etc.) or denies the requested access to the functionality of the mobile device 102 (e.g., by locking access to portions of the operating system 112, application 114, etc.).

In some implementations, the comparison result 214 may include the multispectral sensor data 210 and the recognition result 220 may include the image sensor data 218. The functionality access module 206 may compare the multispectral sensor data 210 with the image sensor data 218 and may generate the device access determination 222 based on the comparison. For example, the functionality access module 206 may perform one or more additional verifications using the multispectral sensor data 210 and the image sensor data 218. In implementations, such additional verifications may include comparisons of the multispectral sensor data 210 with the image sensor data 218. As one example, the functionality access module 206 may generate one or more mappings between the multispectral sensor data 210 and the image sensor data 218.

The mappings may, for example, associate facial features depicted by the image sensor data 218 with corresponding indicators of active biological processes for those facial features described by the multispectral sensor data 210. In situations in which the functionality access module 206 is unable to generate mappings between the image sensor data 218 and the multispectral sensor data 210 due to substantial differences between the facial features depicted by the image sensor data 218 and the indicators of the multispectral sensor data 210, the functionality access module 206 may output device access determination 222 indicating that access to the functionality of the mobile device 102 should not be provided. Such situations may arise, for example, if the indicators described by the multispectral sensor data 210 are associated with a first individual and the facial features depicted by the image sensor data 218 are associated with a different, second individual. Thus, even if the facial features depicted by the image sensor data 218 are associated with an authorized user of the mobile device 102, the functionality access module 206 may determine that the multispectral sensor data 210 and the image sensor data 218 do not correspond to the same individual and may deny access to the functionality of the mobile device 102 to prevent unauthorized individuals from accessing applications, sensitive data, and/or other functionality of the mobile device 102.

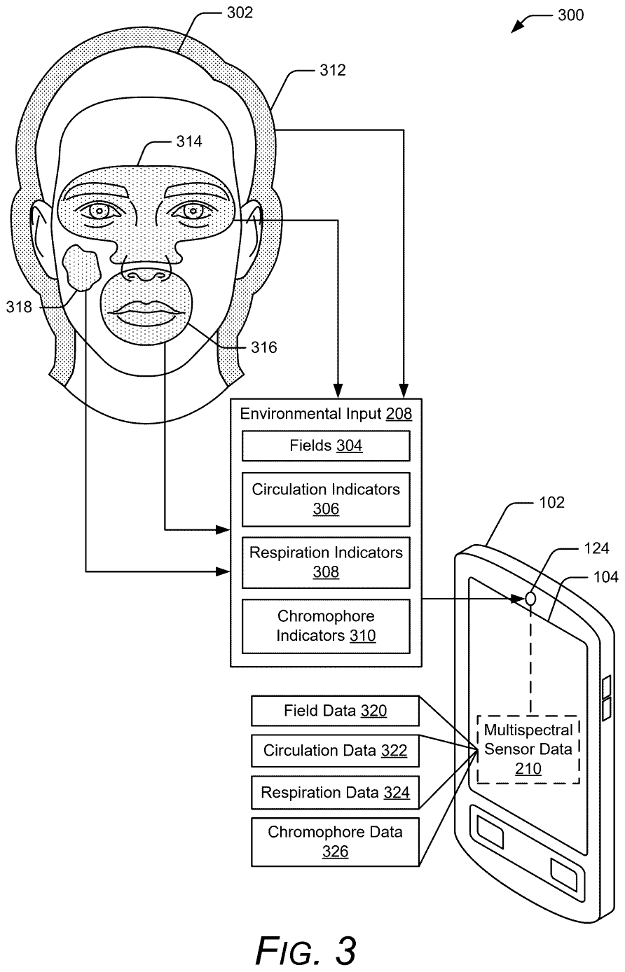

FIG. 3 illustrates an example 300 of acquiring environmental input 208 via the multispectral sensor 124 included in the user authentication system 118 using the techniques discussed herein. The example 300 depicts an individual 302, e.g., a user of the mobile device 102 requesting access to functionality of the mobile device 102. Responsive to the request, the mobile device 102 employs the multispectral sensor 124 to acquire multispectral sensor data 210 describing indicators of active biological processes of the individual 302 in accordance with the techniques described above.

The environmental input 216 is depicted as including fields 304, circulation indicators 306, respiration indicators 308, and chromophore indicators 310. The fields 304 may be electromagnetic fields associated with active biological processes of the individual 302 such as blood flow, brain activity, etc. The fields 304 may be detected by the multispectral sensor 124 within a region 312 surrounding the head of the individual 302, for example.

The circulation indicators 306 may include infrared light emitted by areas of the face of the individual 302, such as area 314 including the eyes of the individual 302, a portion of the forehead of the individual 302, and a portion of the nose of the individual 302. The infrared light may be emitted as a result of blood flow within the area 314. The respiration indicators 308 may include infrared light emitted by respiration gases of the individual 302, e.g., at area 316 proximate to the nose and mouth of the individual 302.

The chromophore indicators 310 may include light reflected by tissues (e.g., skin) of the individual 302, e.g., at area 318 at a cheek of the individual 302. The reflected light may include light in the non-visible spectrum such as ultraviolet light, infrared light, etc. The intensity and wavelength of the reflected light may indicate wavelengths of light that are absorbed by the chromophores and may be used by the active user verification module 202 to determine whether the chromophores are associated with living tissue of the individual 302.

The environmental input 216 is received by the multispectral sensor 124 and the multispectral sensor 124 generates multispectral sensor data 210 as described above. The multispectral sensor data 210 may include field data 320 describing the fields 304 (e.g., intensity, direction, etc. of the fields 304), circulation data 322 describing the circulation indicators 306, respiration data 324 describing the respiration indicators 308, and/or chromophore data 326 describing the chromophore indicators 310. The field data 320, circulation data 322, respiration data 324, and/or chromophore data 326 may be processed by the active user verification module 202. The processing of the multispectral sensor data 210 may include comparing the multispectral sensor data 210 (e.g., the field data 320, circulation data 322, respiration data 324, and/or chromophore data 326) to the reference data 212 as described above.

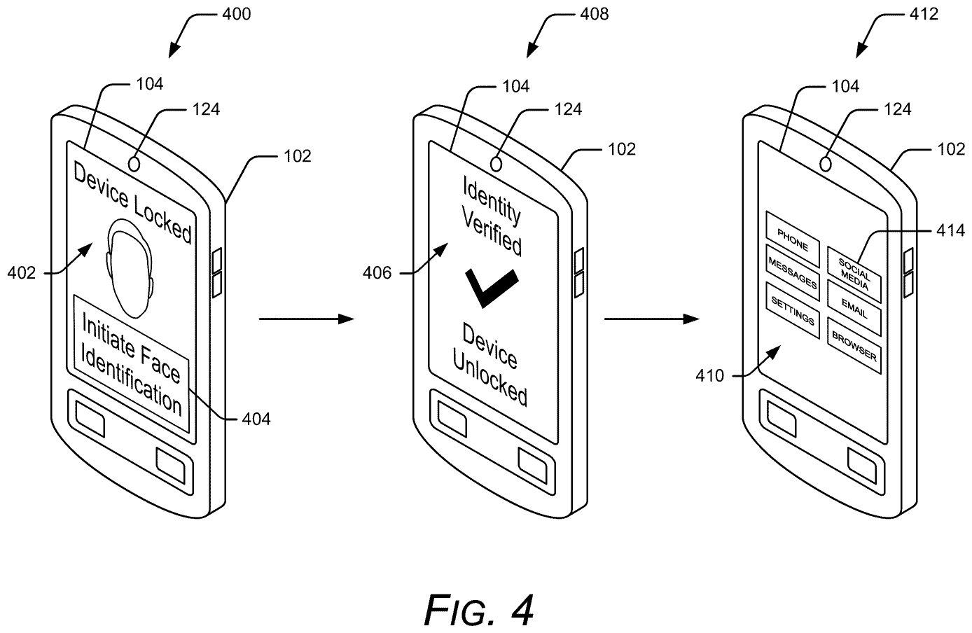

FIG. 4 illustrates various example states of the mobile device 102 while controlling access to functionality of the mobile device 102 using the techniques discussed herein. In particular, an example 400 shows the mobile device 102 in a state in which the user authentication system 118 has initiated a user authentication process. The user authentication process includes the processes described above with reference to FIG. 2. For example, the user authentication process includes generating multispectral sensor data 210, comparing the multispectral sensor data 210 to reference data 212, generating the comparison result 214, generating the recognition result 220, generating the device access determination 222, etc. In the example 400, the user authentication system 118 causes the mobile device 102 to display a graphical user interface 402 indicating that the user authentication process has been initiated. The graphical user interface 402 may include, for example, one or more interface elements (e.g., buttons, icons, etc.) that a user may interact with (e.g., touch, select, etc.) to cause the multispectral sensor 124 to acquire environmental input 208 and generate the multispectral sensor data 210 from the environmental input 208.

The display of the graphical user interface 402 may occur responsive to user input applied to the mobile device 102 to initiate the user authentication process. For example, the graphical user interface 402 may be displayed responsive to input to physical buttons of the mobile device 102, a particular motion of the mobile device 102 within the environment (e.g., shaking the mobile device 102), etc. However, in the depicted example 400, the graphical user interface 402 includes an initiation button 404. An individual may interact with the initiation button 404 to initiate the user authentication process and activate the multispectral sensor 124 (e.g., cause the multispectral sensor 124 to generate multispectral sensor data 210 from the environmental input 208).

The multispectral sensor data 210 is provided to the active user verification module 202 as described above, with the active user verification module 202 generating the comparison result 214 based on the multispectral sensor data 210. Upon generating the device access determination 222 indicating that access to the functionality of the mobile device 102 is to be provided to the individual requesting access, the user authentication system 118 may display a confirmation interface 406 indicating that the access to the functionality is granted as depicted by example 408. However, in some implementations, the confirmation interface 406 may be omitted and the user authentication system 118 may cause the mobile device 102 to proceed directly to displaying a graphical user interface 410 of the operating system 112 as depicted by example 412 without first displaying the confirmation interface 406. In the depicted example 412, the operating system 112 includes graphical user interface elements 414 (such as buttons, icons, etc.) for accessing various features of the mobile device 102 such as messaging applications, browsing applications, or other functionality.

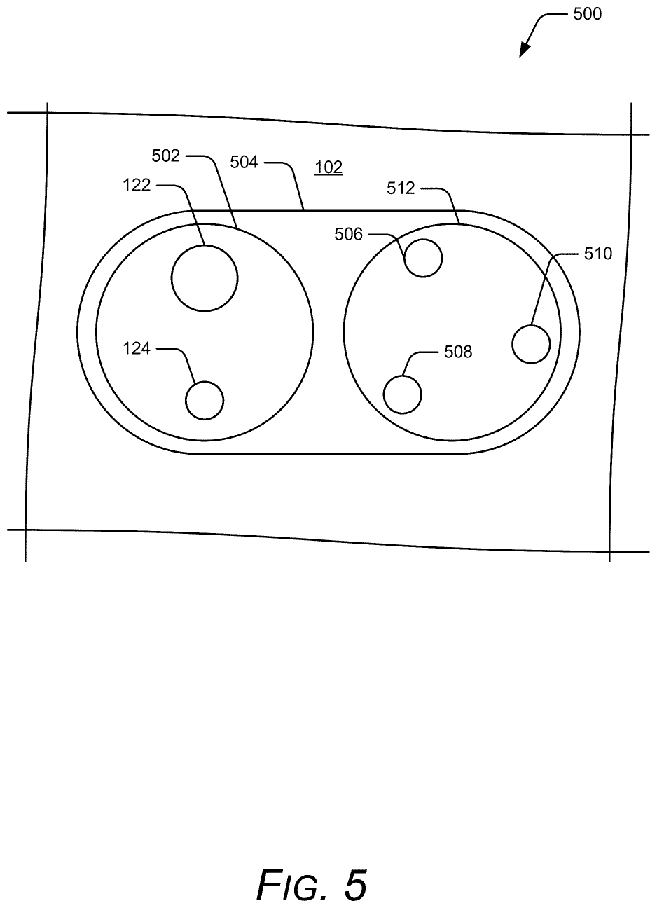

FIG. 5 illustrates an enlarged view of an example 500 of the multispectral sensor 124. In the depicted example 500, the multispectral sensor 124 and the image sensor 122 each utilize a lens 502 for receiving the environmental input 208 and the environmental input 216, respectively, as described above with reference to FIG. 2. In some implementations, the multispectral sensor 124 and the image sensor 122 may utilize separate lenses, separate filters, etc. The multispectral sensor 124 and the image sensor 122 are depicted as components of a camera module 504 of the mobile device 102. The camera module 504 is depicted as additionally including illumination element 506, illumination element 508, and illumination element 510 each using a lens 512. The illumination elements may be employed for performing lighting operations (e.g., camera flash) associated with imaging using the camera module 504, for example.

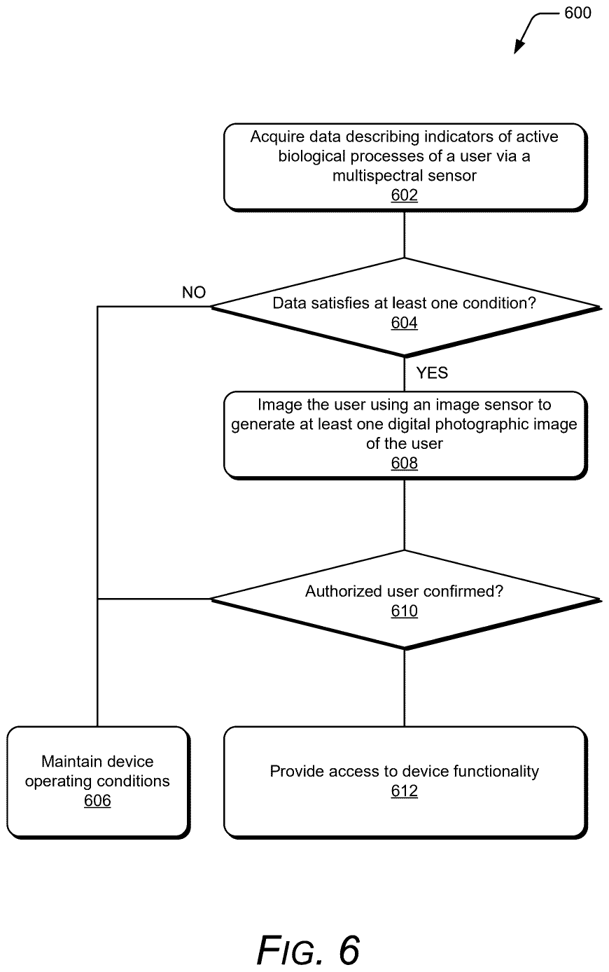

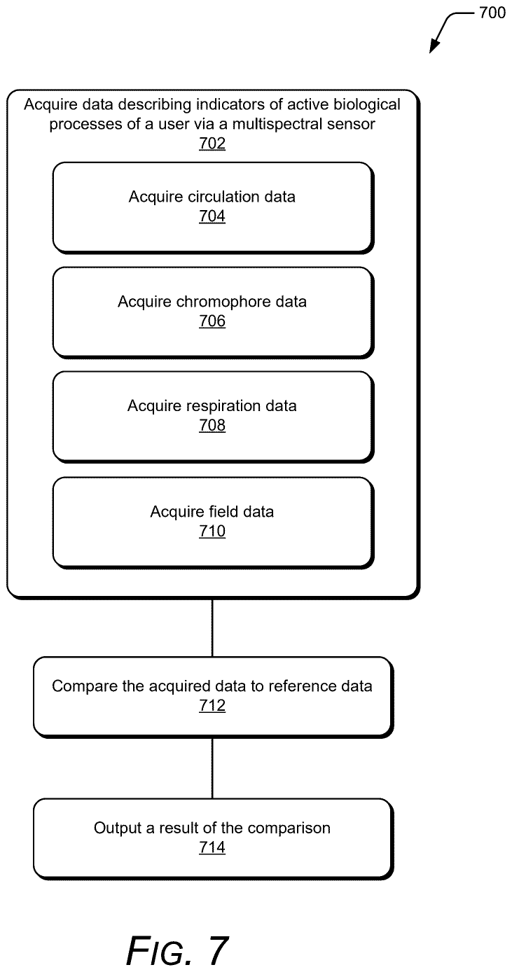

FIGS. 6 and 7 illustrate example processes for implementing the techniques discussed herein in accordance with one or more embodiments. In particular, FIG. 6 illustrates an example process 600 and FIG. 7 illustrates an example process 700. Referring to FIG. 6, process 600 is carried out by a user authentication system, such as the user authentication system 118 of FIG. 1, and can be implemented in software, firmware, hardware, or combinations thereof. Process 600 is shown as a set of acts and is not limited to the order shown for performing the operations of the various acts.

In process 600, data describing indicators of active biological processes of a user is acquired via a multispectral sensor (act 602). By way of example, the multispectral sensor 124 generates multispectral sensor data 210 describing the indicators, such as fields 304, circulation indicators 306, respiration indicators 308, and/or chromophore indicators 310.

Process 600 proceeds based on whether the data satisfies at least one condition (act 604). If the data does not satisfy the at least one condition, the device operating conditions are maintained (act 606). By way of example, maintaining the device operating conditions includes maintaining functionality of the mobile device 102 in the locked mode. However, if the data satisfies the at least one condition, then an image sensor is used to image the user to generate at least one digital photographic image of the user (act 608). By way of example, the active user verification module 202 compares the multispectral sensor data 210 with the reference data 212 and generates comparison result 214 indicating that the at least one condition has been satisfied. In response to providing the comparison result 214 to the functionality access module 206, the image sensor 122 is employed to generate image sensor data 218 depicting facial features of the user.

Process 600 proceeds based on whether an authorized user is confirmed (act 610). If an authorized user is not confirmed, the device operating conditions are maintained as described above (act 606). However, if an authorized user is confirmed, access to device functionality is provided (act 612). By way of example, the identity recognition module 204 determines whether the image sensor data 218 depicts facial features of an authorized user and generates recognition result 220. Responsive to receiving the recognition result 220 indicating that the user is an authorized user, the functionality access module 206 generates device access determination 222 to provide access to the functionality of the mobile device 102.

Referring to FIG. 7, another example process 700 is illustrated for implementing the techniques discussed herein in accordance with one or more embodiments. Process 700 is carried out by a user authentication system, such as user authentication system 118 of FIG. 1, and can be implemented in software, firmware, hardware, or combinations thereof. Process 700 is shown as a set of acts and is not limited to the order shown for performing the operations of the various acts.

In process 700, data describing indicators of active biological processes of a user is acquired via a multispectral sensor (act 702). By way of example, the multispectral sensor data 210 is generated by the multispectral sensor 124 from environmental input 208 as described above.

Acquiring the data describing the indicators may include acquiring circulation data (act 704), acquiring chromophore data (act 706), acquiring respiration data (act 708), and/or acquiring field data (act 710). By way of example, the multispectral sensor data 210 includes the field data 320, the circulation data 322, the respiration data 324, and/or the chromophore data 326, as described above.

The acquired data is compared to reference data (act 712). By way of example, the multispectral sensor data 210 is compared to the reference data 212 by the active user verification module 202 as described above.

A result of the comparison is output (act 714). By way of example, the active user verification module 202 outputs the comparison result 214 based on the comparison of the multispectral sensor data 210 with the reference data 212 as described above.

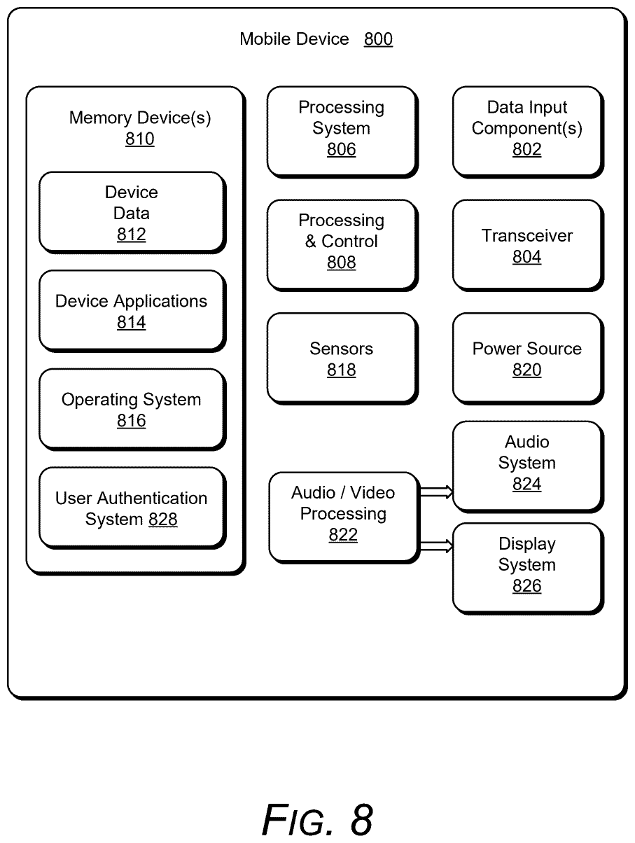

FIG. 8 illustrates various components of an example mobile device 800 in which embodiments of a mobile device user authentication system including a multispectral sensor can be implemented. The mobile device 800 can be implemented as any of the devices described with reference to the previous FIG. s, such as any type of client device, mobile phone, tablet, computing, communication, entertainment, gaming, media playback, or other type of mobile device. In one or more embodiments the mobile device 800 is similar to, or the same as, the mobile device 102, and a user authentication system 828 of the mobile device 800 includes the user authentication system 118, described above.

The mobile device 800 includes one or more data input components 802 via which any type of data, media content, or inputs can be received such as user-selectable inputs, messages, music, television content, recorded video content, and any other type of text, audio, video, or image data received from any content or data source. The data input components 802 may include various data input ports such as universal serial bus ports, coaxial cable ports, and other serial or parallel connectors (including internal connectors) for flash memory, DVDs, compact discs, and the like. These data input ports may be used to couple the mobile device to components, peripherals, or accessories such as keyboards, microphones, or cameras. The data input components 802 may also include various other input components such as microphones, touch sensors, touchscreens, keyboards, and so forth.

The mobile device 800 includes communication transceivers 804 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The mobile device 800 includes a processing system 806 of one or more processors (e.g., any of microprocessors, controllers, and the like) or a processor and memory system implemented as a system-on-chip (SoC) that processes computer-executable instructions. The processing system 806 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 808. The mobile device 800 may further include any type of a system bus or other data and command transfer system that couples the various components within the device. A system bus can include any one or combination of different bus structures and architectures, as well as control and data lines.

The mobile device 800 also includes computer-readable storage memory devices 810 that enable data storage, such as data storage devices that can be accessed by a mobile device, and that provide persistent storage of data and executable instructions (e.g., software applications, programs, functions, and the like). Examples of the computer-readable storage memory devices 810 include volatile memory and non-volatile memory, fixed and removable media devices, and any suitable memory device or electronic data storage that maintains data for mobile device access. The computer-readable storage memory can include various implementations of random access memory (RAM), read-only memory (ROM), flash memory, and other types of storage media in various memory device configurations. The mobile device 800 may also include a mass storage media device.

The computer-readable storage memory device 810 provides data storage mechanisms to store the device data 812, other types of information or data, and various device applications 814 (e.g., software applications). For example, an operating system 816 can be maintained as software instructions with a memory device and executed by the processing system 806. The device applications 814 may also include a device manager, such as any form of a control application, software application, signal-processing and control module, code that is native to a particular device, a hardware abstraction layer for a particular device, and so on.

The mobile device 800 can also include one or more device sensors 818, such as any one or more of an ambient light sensor, a proximity sensor, a touch sensor, an infrared (IR) sensor, accelerometer, gyroscope, thermal sensor, audio sensor (e.g., microphone), and the like. The mobile device 800 can also include one or more power sources 820, such as when the mobile device 800 is implemented as a mobile device. The power sources 820 may include a charging or power system, and can be implemented as a flexible strip battery, a rechargeable battery, a charged super-capacitor, or any other type of active or passive power source.

The mobile device 800 additionally includes an audio/video processing system 822 that generates one or both of audio data for an audio system 824 and display data for a display system 826. In accordance with some embodiments, the audio/video processing system 822 is configured to receive call audio data from the transceiver 804 and communicate the call audio data to the audio system 824 for playback at the mobile device 800. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for a mobile device user authentication system including a multispectral sensor have been described in language specific to features or methods, the subject of the appended claims is not necessarily limited to the specific features or methods described. Rather, the specific features and methods are disclosed as example implementations of techniques for implementing a mobile device user authentication system including a multispectral sensor. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a mobile device, including: at least one memory; and at least one processor coupled with the at least one memory and configured to cause the mobile device to: compare indicators of one or more active biological processes of a user to reference data; determine whether the indicators satisfy at least one condition based on the reference data; and control access to a functionality of the mobile device based at least in part on the indicators satisfying the at least one condition.

In some aspects, the techniques described herein relate to a mobile device, wherein the at least one processor is configured to cause the mobile device to detect the indicators using a multispectral sensor, and the one or more active biological processes include user respiration or user circulation.

In some aspects, the techniques described herein relate to a mobile device, wherein the indicators include infrared light emission associated with an active circulation process of the user or an active respiration process of the user.

In some aspects, the techniques described herein relate to a mobile device, wherein the at least one processor is configured to cause the mobile device to detect the indicators using a multispectral sensor, and the indicators include an electromagnetic field or chromophores associated with active human facial features.

In some aspects, the techniques described herein relate to a mobile device, wherein the at least one processor is configured to cause the mobile device to: acquire image data depicting user facial features via an image sensor; process the image data to perform a verification of whether the user facial features are associated with one or more authorized users; and control access to the functionality of the mobile device further based on the verification.

In some aspects, the techniques described herein relate to a mobile device, wherein the at least one processor is configured to cause the mobile device to process the image data to perform the verification responsive to determining that the indicators satisfy the at least one condition.

In some aspects, the techniques described herein relate to a mobile device, wherein the at least one processor is configured to cause the mobile device to perform a comparison of the indicators to the image data and control access to the functionality of the mobile device further based on the comparison.

In some aspects, the techniques described herein relate to a mobile device, wherein the at least one processor is configured to cause the mobile device to generate at least one mapping between the indicators and the image data.

In some aspects, the techniques described herein relate to a mobile device, wherein access to the functionality of the mobile device includes access to at least one application of the mobile device.

In some aspects, the techniques described herein relate to a mobile device, wherein the at least one processor is configured to cause the mobile device to determine whether the indicators satisfy the at least one condition based on the reference data using a machine-learning model, the machine-learning model trained to detect similarity between the indicators and the reference data.

In some aspects, the techniques described herein relate to a mobile device, wherein the indicators are described by two-dimensional infrared emission data acquired by a multispectral sensor of the mobile device.

In some aspects, the techniques described herein relate to a mobile device, wherein the reference data describes one or more thresholds, and the at least one condition is based on the one or more thresholds.

In some aspects, the techniques described herein relate to a mobile device, wherein the one or more thresholds include at least one of an infrared light intensity threshold, an electromagnetic field intensity threshold, or a chromophore reflectance threshold.

In some aspects, the techniques described herein relate to a mobile device, wherein the at least one condition describes a threshold similarity between the reference data and the indicators.

In some aspects, the techniques described herein relate to a mobile device, wherein the at least one processor is configured to cause the mobile device to acquire two-dimensional infrared data and electromagnetic field data using a multispectral sensor and identify the indicators from one or more of the two-dimensional infrared data and the electromagnetic field data.

In some aspects, the techniques described herein relate to a method performed by a mobile device, the method including: comparing indicators of one or more active biological processes of a user to reference data; determining whether the indicators satisfy at least one condition based on the reference data; and controlling access to a functionality of the mobile device based at least in part on the indicators satisfying the at least one condition.

In some aspects, the techniques described herein relate to a method, further including: acquiring image data depicting user facial features via an image sensor; responsive to determining that the indicators satisfy the at least one condition, processing the image data to perform a verification of whether the user facial features are associated with one or more authorized users; and controlling access to the functionality of the mobile device further based on the verification.

In some aspects, the techniques described herein relate to a method, further including detecting the indicators using a multispectral sensor, the indicators including infrared light emission associated with an active circulation process of the user, infrared light emission associated with an active respiration process of the user, or an electromagnetic field or chromophores associated with active facial features of the user.

In some aspects, the techniques described herein relate to a system including: at least one memory; and at least one processor coupled with the at least one memory and configured to cause the system to: compare indicators of one or more active biological processes of a user to reference data; determine whether the indicators satisfy at least one condition based on the reference data; and control access to a functionality of at least one application based at least in part on the indicators satisfying the at least one condition.

In some aspects, the techniques described herein relate to a system, wherein the at least one processor is configured to cause the system to: detect the indicators using a multispectral sensor; acquire image data depicting user facial features via an image sensor; responsive to determining that the indicators satisfy the at least one condition, process the image data to perform a verification of whether the user facial features are associated with one or more authorized users; and control access to the functionality of the at least one application further based on the verification.

What is claimed is:

1. A mobile device, comprising:
at least one memory; and
at least one processor coupled with the at least one memory and configured to cause the mobile device to:
compare indicators of one or more active biological processes of a user to reference data;
determine whether the indicators satisfy at least one condition based on the reference data; and
control access to a functionality of the mobile device based at least in part on the indicators satisfying the at least one condition.

2. The mobile device of claim 1, wherein the at least one processor is configured to cause the mobile device to detect the indicators using a multispectral sensor, and the one or more active biological processes include user respiration or user circulation.

3. The mobile device of claim 1, wherein the indicators include infrared light emission associated with an active circulation process of the user or an active respiration process of the user.

4. The mobile device of claim 1, wherein the at least one processor is configured to cause the mobile device to detect the indicators using a multispectral sensor, and the indicators include an electromagnetic field or chromophores associated with active human facial features.

5. The mobile device of claim 1, wherein the at least one processor is configured to cause the mobile device to:
acquire image data depicting user facial features via an image sensor;
process the image data to perform a verification of whether the user facial features are associated with one or more authorized users; and
control access to the functionality of the mobile device further based on the verification.

6. The mobile device of claim 5, wherein the at least one processor is configured to cause the mobile device to process the image data to perform the verification responsive to determining that the indicators satisfy the at least one condition.

7. The mobile device of claim 5, wherein the at least one processor is configured to cause the mobile device to perform a comparison of the indicators to the image data and control access to the functionality of the mobile device further based on the comparison.

8. The mobile device of claim 5, wherein the at least one processor is configured to cause the mobile device to generate at least one mapping between the indicators and the image data.

9. The mobile device of claim 1, wherein access to the functionality of the mobile device includes access to at least one application of the mobile device.

10. The mobile device of claim 1, wherein the at least one processor is configured to cause the mobile device to determine whether the indicators satisfy the at least one condition based on the reference data using a machine-learning model, the machine-learning model trained to detect similarity between the indicators and the reference data.

11. The mobile device of claim 1, wherein the indicators are described by two-dimensional infrared emission data acquired by a multispectral sensor of the mobile device.

12. The mobile device of claim 1, wherein the reference data describes one or more thresholds, and the at least one condition is based on the one or more thresholds.

13. The mobile device of claim 12, wherein the one or more thresholds include at least one of an infrared light intensity threshold, an electromagnetic field intensity threshold, or a chromophore reflectance threshold.

14. The mobile device of claim 1, wherein the at least one condition describes a threshold similarity between the reference data and the indicators.

15. The mobile device of claim 1, wherein the at least one processor is configured to cause the mobile device to acquire two-dimensional infrared data and electromagnetic field data using a multispectral sensor and identify the indicators from one or more of the two-dimensional infrared data and the electromagnetic field data.

16. A method performed by a mobile device, the method comprising:
comparing indicators of one or more active biological processes of a user to reference data;
determining whether the indicators satisfy at least one condition based on the reference data; and
controlling access to a functionality of the mobile device based at least in part on the indicators satisfying the at least one condition.

17. The method of claim 16, further comprising:
acquiring image data depicting user facial features via an image sensor;
responsive to determining that the indicators satisfy the at least one condition, processing the image data to perform a verification of whether the user facial features are associated with one or more authorized users; and
controlling access to the functionality of the mobile device further based on the verification.

18. The method of claim 16, further comprising detecting the indicators using a multispectral sensor, the indicators including infrared light emission associated with an active circulation process of the user, infrared light emission associated with an active respiration process of the user, or an electromagnetic field or chromophores associated with active facial features of the user.

19. A system comprising:
at least one memory; and
at least one processor coupled with the at least one memory and configured to cause the system to:
compare indicators of one or more active biological processes of a user to reference data;
determine whether the indicators satisfy at least one condition based on the reference data; and
control access to a functionality of at least one application based at least in part on the indicators satisfying the at least one condition.

20. The system of claim 19, wherein the at least one processor is configured to cause the system to:
detect the indicators using a multispectral sensor;
acquire image data depicting user facial features via an image sensor;
responsive to determining that the indicators satisfy the at least one condition, process the image data to perform a verification of whether the user facial features are associated with one or more authorized users; and
control access to the functionality of the at least one application further based on the verification.
